(19) United States
(12) Patent Application Publication
(10) Pub. No.: US 2022/0397876 A1
(43) Pub. Date: Dec. 15, 2022

(54) OFF-GRID POWER GENERATION AND CONVERSION METHODS AND RELATED SYSTEMS

(71) Applicant: Evolve Gas and Power LLC, Houston, TX (US)

(72) Inventors: John Robert Battershell, Spring, TX (US); Tye Aron Johnson, Spring, TX (US); Justin Klay Moody, Friendswood, TX (US)

(73) Assignee: Evolve Gas and Power LLC, Houston, TX (US)

(21) Appl. No.: 17/836,263

(22) Filed: Jun. 9, 2022

Related U.S. Application Data
(60) Provisional application No. 63/209,166, filed on Jun. 10, 2021.

(51) Int. Cl. G05B 19/042

(52) U.S. Cl. CPC G05B 19/042; G05B 2219/2639

(57) ABSTRACT

A system and related method of generating and utilizing electrical energy flows a gas along a pipeline, generates electricity by reducing the pressure of the gas at selected locations along the pipeline, and operates an energy consumer using at least a portion of the generated electricity.

### CROSS-REFERENCE TO RELATED APPLICATION

This application claims the benefit of Provisional Patent Application No. 63/209,166 filed Jun. 10, 2021, which is incorporated by reference herein in its entirety.

### TECHNICAL FIELD

The present disclosure relates to devices and methods for generating electrical power at off-grid locations and/or locations where available energy may be stranded and wasted.

### BACKGROUND

Conventionally, utility companies, or “power producers,” convert available energy such as hydrocarbons or renewable energy into electrical power, which is then feed into an electrical grid that distributes the electrical power to one or more end users. In aspects, the present disclosure addresses the need to utilize available energy that is not connected to an electrical grid, as well as other needs of the prior art.

### SUMMARY

In aspects, the present disclosure provides a method for nodal electrical energy generation and consumption for a natural gas pipeline. The method may include providing at least one pressure increasing node at a first selected location along the pipeline, the node configured to increase a pressure of the gas in the pipeline to at least a predetermined value; providing at least one self-sustaining node at a second selected location on the pipeline that is downstream of the first selected location, the at least one-self sustaining node including at least one energy extractor and at least one load, the at least one energy extractor being configured to convert a differential pressure of a gas in the pipeline to electrical energy; flowing the gas along the pipeline; generating electricity using the at least one self-sustaining node; and supplying at least a portion of the generated electricity to the load.

In aspects, the present disclosure also provides a method of generating and utilizing electrical energy that includes the steps of: flowing gas along a pipeline; increasing a pressure of the gas using at least one pressure increasing station at a location that are upstream of the at least one selected location along the pipeline; generating electricity by reducing the pressure of the gas at at least one selected location along the pipeline; processing data using at least a portion of the generated electricity; and transmitting at least a portion of the processed data to at least one receiver using at least one of: (i) a wireless transmitter, and (ii) at least one fiber optic cable.

In aspects, the present disclosure also provides a method of generating and utilizing electrical energy that includes the steps of: flowing a gas along a pipeline; generating electricity by reducing the pressure of the gas at selected locations along the pipeline; generating hydrogen using at least a portion of the generated electricity; and conveying at least a portion of the generated hydrogen using the pipeline.

In aspects, the present disclosure also provides a method of retrofitting a pipeline to generate and utilize electrical energy that includes the steps of: installing a bypass along the pipeline; connecting a turboexpander and a generator to the bypass; flowing a gas along the pipeline; diverting a portion of the gas in the pipeline to the turboexpander and the generator using the bypass; generating electricity using the turboexpander and the generator and the diverted portion of the gas; processing data using at least a portion of the generated electricity; and transmitting at least a portion of the processed data to at least one receiver using at least one of: (i) a wireless transmitter, and (ii) at least one fiber optic cable.

In aspects, the present disclosure also provides a method of retrofitting a pipeline to enhance electrical energy generation and utilize electrical energy that includes the steps of: installing a bypass line to bypass a pressure reduction valve along the pipe line, the bypass line being connected to a turboexpander and a generator; flowing a gas along the pipeline; increasing the temperature of the gas at a location on the pipeline upstream of the turboexpander; diverting a portion of the gas in the pipeline to the turboexpander and the generator using the bypass; generating electricity using the turboexpander and the generator and diverted portion of the gas; processing data using at least a portion of the generated electricity; and transmitting at least a portion of the processed data to at least one receiver using at least one of: (i) a wireless transmitter, and (ii) at least one fiber optic cable.

In aspects, the present disclosure also provides a method of generating and utilizing electrical energy that includes the steps of: flowing a gas along a pipeline; generating electricity by reducing the pressure of the gas at at least one node along the pipeline; and positioning at least one energy consumer at the at least one node; operating the at least one energy consumer using at least a portion of the generated electricity.

In aspects, the present disclosure also provides a method of generating and utilizing electrical energy that includes the steps of: flowing gas along a pipeline; increasing pressure of the gas at at least one pressure increasing station positioned along the pipeline at locations that are upstream of the selected location along the pipeline; generating electricity by reducing the pressure of the gas at selected locations along the pipeline; processing data using at least a portion of the generated electricity; and wirelessly transmitting at least a portion of the processed data to at least one receiver; transmitting at least a portion of the processed data through at least one fiber optic cable.

In aspects, the present disclosure also provides a method of generating and utilizing electrical energy that includes the steps of: flowing a gas along a pipeline; generating electricity by reducing the pressure of the gas at selected locations along the pipeline; generating hydrogen using at least a portion of the generated electricity; and conveying at least a portion of the generated hydrogen using the pipeline.

In aspects, the present disclosure also provides a method of retrofitting a pipeline to generate and utilize electrical energy that includes the steps of: bypassing a pressure reduction valve along the pipe line with a turboexpander and a generator; flowing a gas along a pipeline; generating electricity using the turboexpander and the generator; processing data using at least a portion of the generated electricity; and wireless transmitting at least a portion of the processed data to at least one receiver; transmitting at least a portion of the processed data through at least one fiber optic cable.

In aspects, the present disclosure also provides a method of retrofitting a pipeline to enhance electrical energy generation and utilize electrical energy that includes the steps of: bypassing a pressure reduction valve along the pipe line with a turboexpander and a generator; flowing a gas along a pipeline; increasing the temperature of the gas prior to the turboexpander; generating electricity using the turboexpander and the generator; processing data using at least a portion of the generated electricity; and wireless transmitting at least a portion of the processed data to at least one receiver; transmitting at least a portion of the processed data through at least one fiber optic cable.

In aspects, the present disclosure also provides a method of generating and utilizing electrical energy that includes the steps of flowing a gas along a pipeline; generating electricity by reducing the pressure of the gas at selected locations along the pipeline; and operating an energy consumer using at least a portion of the generated electricity.

In aspects, the present disclosure also provides a system for recovering utility from at least one gas under a first pressure in a gas pipeline. The system may include a recovery station coupled to the gas pipeline and configured to pass through at least a portion of the gas at a second pressure lower than the first pressure, comprising: a bypass line in communication with the gas pipeline; an exit line dispensing gas at the second pressure; and an electrical generator configured to receive the gas at the first pressure from the bypass line and produce electricity via a difference between the first pressure and the second pressure; and a digital asset token generation station at the recovery station, comprising: at least one processor connected to a network and configured to: determine validity of a transaction record received from the network by performing a proof of work operation on the transaction record; and direct storage of digital asset tokens earned from the proof of work operation in memory accessible to the system; and an electrical system providing at least a portion of the electricity from the electrical generator to the digital asset token generation station.

In aspects, the present disclosure also provides a system for producing carbon credits from a gas pipeline having at least one gas under a first pressure, the system comprising: a recovery station coupled to the gas pipeline and configured to pass through at least a portion of the gas at a second pressure lower than the first pressure, the recovery station comprising: a bypass line in communication with the gas pipeline; an exit line dispensing the gas at the second pressure; and an electrical generator configured to receive the gas at the first pressure from the bypass line and produce electricity via a difference between the first pressure and the second pressure; and a hydrogen generation station at the recovery station, the hydrogen generation station comprising: a water source; an electrolysis module configured to convert water from the water source into hydrogen and oxygen by electrolysis; and at least one sensor configured to measure a parameter value of the hydrogen; an electrical system providing at least a portion of the electricity from the electrical generator to the hydrogen generation station; and at least one a processor configured to estimate a carbon credit based on the parameter value.

In aspects, the present disclosure also provides a system for nodal electrical energy generation and consumption for a natural gas pipeline. The system may include at least one pressure increasing node at a first selected location along the pipeline, the node configured to increase a pressure of the gas in the pipeline to at least a predetermined value; and at least one self-sustaining node at a second selected location on the pipeline that is downstream of the first selected location, the at least one-self sustaining node including at least one energy extractor and at least one load, the at least one energy extractor being configured to convert a differential pressure of a gas in the pipeline to electrical energy.

It should be understood that certain features of the disclosure have been summarized rather broadly in order that the detailed description thereof that follows may be better understood, and in order that the contributions to the art may be appreciated. There are, of course, additional features of the disclosure that will be described hereinafter and which will in some cases form the subject of the claims appended thereto.

### BRIEF DESCRIPTION OF THE DRAWINGS

For detailed understanding of the present disclosure, references should be made to the following detailed description taken in conjunction with the accompanying drawings, in which like elements have been given like numerals and wherein:

FIG. 1 schematically illustrates a power utilization module according to one embodiment of the present disclosure;

FIG. 2 schematically illustrates a pipeline complex that includes power utilization modules according to embodiments of the present disclosure;

FIG. 3 schematically illustrates another power utilization module according to one embodiment of the present disclosure;

FIG. 4 depicts a flow chart illustrating a method for implementing power utilization modules according embodiments of the present disclosure; and

FIG. 5 schematically illustrates a power utilization module according to one embodiment of the present disclosure that is used in connection with a hydrodynamic system.

### DETAILED DESCRIPTION

The present disclosure relates to devices and methods for utilizing energy from sources that are isolated from an electrical grid that transfers electrical power from one or more producers to one or more consumers. By “utilizing,” it is meant generating electricity using the isolated source and using the electricity to energize loads that produce desired outputs, such as data or hydrogen. By “isolated,” it is meant that providing the infrastructure to connect such a source to an electrical grid is prevented by obstacles that include, but are not limited to terrain, distance, regulatory issues, financial constraints, etc. The term “off-grid” will also be used to refer to being isolated from an electrical grid. As will be appreciated, embodiments of the present disclosure beneficially utilize energy that would otherwise be wasted. Thus, energy that has conventionally been stranded may be utilized in a “green” manner to create useful output streams.

The present disclosure is susceptible to embodiments of different forms. There are shown in the drawings, and herein will be described in detail, specific embodiments of the present disclosure with the understanding that the present disclosure is to be considered an exemplification of the principles of the disclosure, and is not intended to limit the disclosure to that illustrated and described herein.

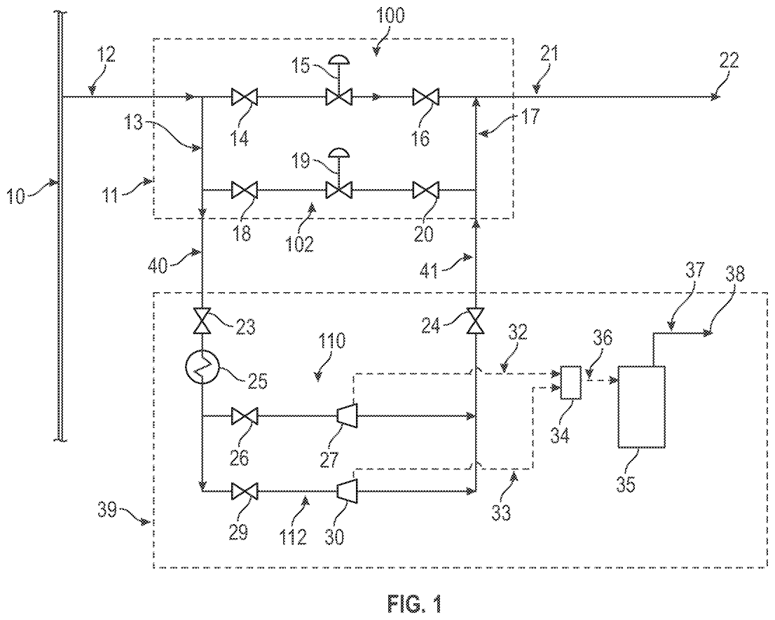

Referring to FIG. 1, there is schematically illustrated one embodiment of a power utilization module 39 made in accordance with the present disclosure that may be integrated into a pipeline 10 that conveys a gas, such as natural gas. In this embodiment, the power utilization module 39 is deployed at a pressure letdown station 11 that receives gas from the pipeline 10 via a feeder line 12. In embodiments of the present disclosure, the pressure letdown station 11 is isolated from a utility power grid. The system described herein may be considered “nodal” because each location may autonomously generate electrical energy and consume the generated electrical energy for one or more purposes.

The pressure letdown station 11 may be of conventional design and include one or more pressure letdown assemblies 100, 102. A first bypass line 13 supplies gas from the feeder line 12 to the pressure letdown assembly 102. A second bypass line 17 conveys gas from the pressure letdown assembly 102 via a line 17 to a pipeline 21 that may connect with receiving station 22, which may be a city gage or industrial complex. The pressure letdown assembly 100 may include a first isolation valve 14, a pressure reducing valve 15, and a second isolation valve 16. Similarly, the pressure letdown assembly 102 may include a first isolation valve 18, a pressure reducing valve 19, and a second isolation valve 20. The pressure letdown assembly 100 may be a primary letdown mechanism and the pressure letdown assembly 102 may be a back-up letdown assembly. In other arrangements, there may be only one pressure letdown assembly or three or more pressure letdown assemblies.

In a conventional manner, the pressure letdown station 11 may be configured to reduce a pressure of the gas in the feeder line 12, which receives gas from the pipeline 10. Upstream of the feeder line 12, pressure increaser (not shown), such as a compressor, has increased the pressure of gas to a transmission pressure. The transmission pressure may be selected to flow a desired volume of gas at a desired rate a desired distance along the pipeline 10. Generally, the transmission pressure may be too high for a receiving station to safely accept. The pressure letdown station 11 reduces the pressure of the gas from the transmission pressure to a lower pressure, which may be termed the “distribution pressure.” It should be noted that the drop in pressure at the pressure letdown station 11 may be carefully controlled to ensure that the gas exiting via the line 21 has sufficient energy to travel to the receiving station 22. Also, the drop in pressure may be controlled to prevent or minimize any undesirable changes to gas; e.g., phase change, cryogenic temperatures, etc.

Aspects of the present disclosure implement a power utilization module 39 in a hydraulically parallel fashion with the pressure letdown station 11. For example, a high pressure line 40 may draw gas from the first bypass line 13 and a low pressure line 41 may return gas to the second bypass line 17. In some situations, only a portion of the gas is drawn from the first bypass line 13. In such situations, the power utilization module 39 operates in conjunction with the pressure letdown station 11. In other situations, all of the gas is drawn from the first bypass line 13. In those situations, the power utilization module 39 operates in place of the pressure letdown station 11. In either case, as further described below, the drawn gas is utilized to energize co-located energy consumers. By “co-located,” it is meant that the energy consumer is supplied electrical power without access to a utility power grid. By “energy consumer,” it is meant a system or device that utilizes electrical energy to provide a desired output. An “energy consumer” may also be referred to as an “electrical load,” or simply “load.”

In one embodiment, the power utilization module 39 may include a plurality of power generating units 110, 112 that are configured to generate electricity by reducing the pressure of the drawn gas from the transmission pressure to a lower pressure, which may be the distribution pressure. In one non-limiting embodiment, the power generation unit 110 may include a first isolation valve 26and a power generator 27. Optionally, an isolation unit (not shown) may be used on this line. The power generation unit 112 may also include a first isolation valve 29 and a power generator 30. Optionally, an isolation unit (not shown) may be used on this line. An inlet isolation valve 23 may be used to selectively control flow along the high pressure line 40 to the power generation units 110, 112 and a return isolation valve 24 may be used to selectively control flow along the low pressure line 41 from the power generation units 110, 112. In some embodiments, a heater 25 may be used to heat the gas flowing to the power generation units 110, 112. Electricity generated by the power generation units 110, 112 are conveyed via suitable electrical power lines 32, 33 respectively, to an electrical distribution unit 34.

In embodiments, the power generator contains a high speed centrifugal turboexpander impeller directly connected to the shaft of the electrical generator device. All of the rotating components are located within the pressure containing vessel. The inlet gas port is also inline directly with the discharge gas port so that the device conveniently fits into the piping arrangement.

The power generator can also be of other types machinery, not limited to the ones described herein. One type can be a high speed turboexpander impeller connected to a gear reduction unit which reduces the high speed turboexpander shaft down to a lower output speed for the electrical generator. Typically, this lower speed is 3600 rpm or slower. Another type of electrical generator can be a positive displacement rotary unit which expands the gas through a screw type expander which is connected to an electrical generator. Another type of positive displacement device can be a reciprocating piston type expander that has the crankshaft connected directly to an electrical generator or through a gear reduction unit. Furthermore, a power generating unit can be a high speed turboexpander impeller connected directly to the shaft of the electrical generating device but in which the connecting inlet gas port to the impeller is offset to the discharge gas port and is not inline with the inlet port.

It should be also appreciated that the power generation units 110, 112 may also provide additional flow assurance to the pressure letdown station 11. That is, the power generating module 39 can serve as the primary pressure regulating device in situations where the primary pressure reducing valve 15 and secondary pressure reducing valve 19 are disabled or not functioning as intended.

The power utilization module 39 also includes one or more co-located energy consumers 35 that receive electrical power 36 from the electrical distribution unit 34. The energy consumers 35 produce an output 37 that is conveyed to a remote receiver 38. Illustrative energy consumers 35 are described below.

One non-limiting example of the energy consumer 35 is a data processing facility. The data processing facility may include known components such as servers, memory modules, routers, etc. The data processing facility uses the generated electricity to process data and transmit some or all of the processed data to a remote receiver. The transmission may be done wirelessly; e.g., satellite, radio, Wi-Fi, Bluetooth, etc. The transmission may also be done using electrical conductors extending from the energy consumer 35 to the remote receiver 38; e.g., by using optical fiber cable or copper cable. In some non-limiting embodiments, the data processing facility may be programmed to mine cryptocurrency.

Another non-limiting example of the energy consumer 35 is a hydrogen generator. The hydrogen generator may be of conventional design and use the generated electricity and a feed water (not shown) to generate hydrogen gas. In some embodiments, some or all the generated hydrogen gas may be conveyed to a remote user by feeding the generated hydrogen gas into the line 21. Thus, the line 21 carries both gas and the hydrogen gas. In some embodiments, some or all of the generated hydrogen gas may be stored in container and transported by vehicles to a remote receiver.

Still another non-limiting example of the energy consumer 35 is an electrical heater. The heater may include heating elements that are thermally coupled to sections of the pipeline 10, the pressure letdown station 11 including the pressure reducing valves 15, 16, power utilization module 39, or any other device or system that may experience operational disruption due to cold weather.

In one mode of operation, some or all of the gas in the first bypass line 13 is directed to the power distribution module 39. The power generation units 110, 112 use the relatively high-pressure gas in the high-pressure line 40 to generate electricity. It should be noted that in most conditions, no hydrocarbons are burned to generate this electricity. Therefore, in certain circumstances, carbon credits may be awarded during operation of the power generation module 39. In certain conditions, some hydrocarbon gas is burned in the heater 25, thus reducing, but not eliminating, the carbon credits. Moreover, it should be noted that the data processing, which may involve mining cryptocurrency, is performed without burning hydrocarbons or small amounts of hydrocarbons.

In conjunction with or alternative to energizing data processing equipment, the electricity may be used to generate hydrogen gas using a hydrogen generator. It should be again noted that no hydrocarbons are burned to generate this electricity. Therefore, the generated hydrogen gas may be considered “green” hydrogen gas. In certain circumstances, carbon credits may be awarded during operation of the power generation module 39 for the generation of the “green” hydrocarbon gas.

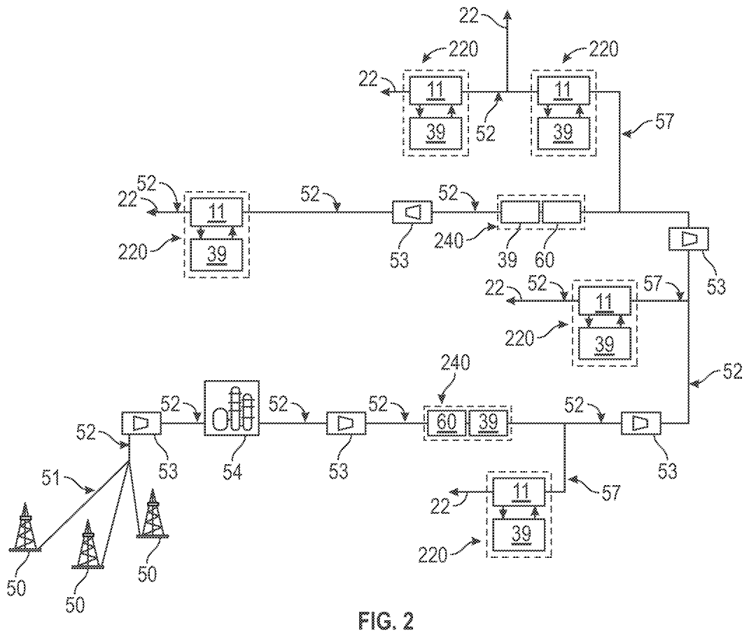

Referring now to FIG. 2, there is shown a non-limiting embodiment of a pipeline complex 200 in accordance with an embodiment of the present disclosure. The pipeline complex 200 may be constructed to transport hydrocarbon gas from a hydrocarbon producing field serviced by one or more wells 50 to one or more destinations 22, which may be a city gate, industrial complex, light commercial complex, business offices, a residential neighborhood, etc. The pipeline complex may include a fluid transmission line that includes gas lines 51 from individual wells 50 to a main distribution line 52 that services one or more destinations 22. A gas processing station 54 may process the gas from the wells 50 in order to achieve “pipeline quality” standards and end use.

The main distribution line 52 may span dozens or hundreds of miles. In order to induce flow of gas along the main distribution line 52, energy is added at selected locations 53 along the main distribution line 52 to increase the pressure of the gas. The increased pressure creates a pressure differential that induces gas flow. In some embodiments, energy is added to gas using compressors.

In embodiments, the pipeline complex 200 extracts some of the energy in the main distribution line 52 at one or more extraction complexes 210. Each extraction complex 210 may include a pressure letdown station 11 and a power generating module 39, both of which have been already described. One or more of the complexes 210 are located inside a zone 220 that is isolated from an electrical grid. Therefore, some or all the electricity generated at each complex 210 is consumed by co-located energy consumers. The generated electrical energy is not fed into an electrical grid having unrelated electrical power producers and consumers. By “unrelated,” it is meant the power producers and consumers are not operationally or structurally associated with the operation of the pipeline complex 200.

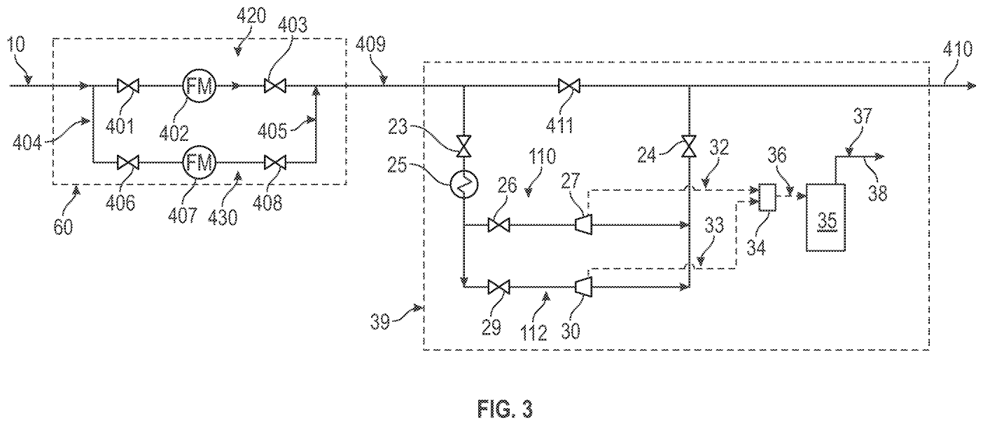

Referring now to FIG. 3, there is shown another non-limiting embodiment of a pipeline complex 200 in accordance with an embodiment of the present disclosure. In FIG. 3, the power generating module 39 is used in a hydraulically parallel to other equipment pipeline equipment. Instead, the power generating module 39 is hydraulically serially aligned to other pipeline structures, such as one or more metering complexes 230. Each metering complex may include a metering station 60 and a power generating module 39. The metering station 60 may be configured to evaluate the quantity and quality of the gas being conveyed along the pipeline 10. One or more of the metering complexes 230 are located inside a zone 240 that is isolated from the electrical grid. Therefore, some or all the electricity generated at each complex 230 is consumed by co-located energy consumers. The generated electrical energy is not fed into an electrical grid having unrelated electrical power producers and consumers. By “unrelated,” it is meant the power producers and consumers are not operationally or structurally associated with the operation of the pipeline complex 200.

As previously described, the power utilization module 39 may include a plurality of power generating units 110, 112 that are configured to generate electricity by reducing the pressure of the drawn gas from the transmission pressure to a lower pressure, which may or may not be the distribution pressure. For example, the difference between the transmission pressure and the lower pressure may be an estimated amount excess pressure. A valve 411 may be used to selectively divert gas from the line 10 to the power utilization module 39.

In one non-limiting embodiment, the power generation unit 110 may include a first isolation valve 26 and a power generator 27. Optionally, an isolation unit (not show) may be used on this line. The power generation unit 112 may also include a first isolation valve 29 and a power generator 30. Optionally, an isolation unit (not shown) may be used on this line. An inlet isolation valve 23 may be used to selectively control flow along the high pressure line 40 to the power generation units 110, 112 and a return isolation valve 24 may be used to selectively control flow along the low pressure line 41 from the power generation units 110, 112. In some embodiments, a heater 25 may be used to heat the gas flowing to the power generation units 110, 112. Electricity generated by the power generation units 110, 112 are conveyed via suitable electrical power lines 32, 33 respectively, to an electrical distribution unit 34. The power utilization module 39 also includes one or more co-located energy consumers 35 that receive electrical power 36 from the electrical distribution unit 34. The energy consumers 35 produce an output 37 that is conveyed to a remote receiver 38.

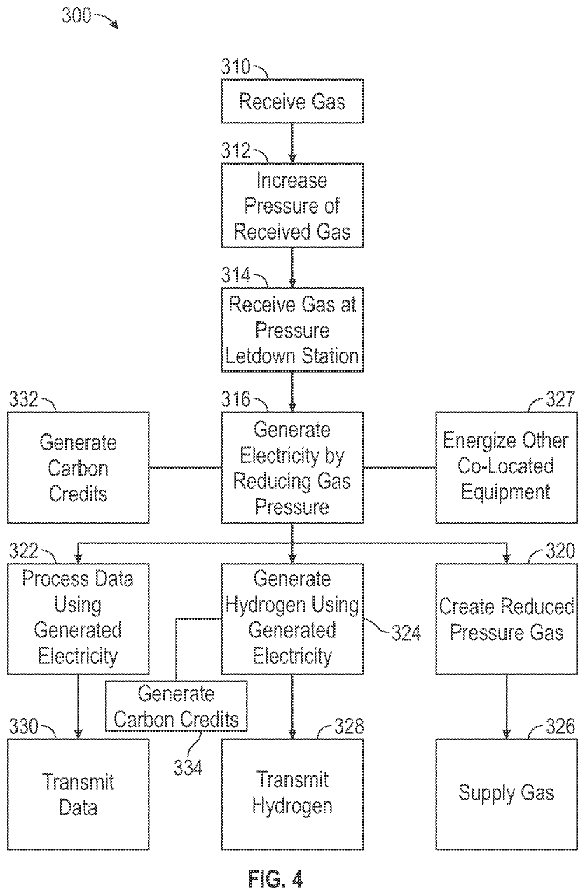

Referring to FIG. 4, there is illustrated a non-limiting embodiment of a method 300 of energy utilization in accordance with the present disclosure. Generally, the method 300 adds energy to a pipeline in order to generated multiple “product” streams. The term “product” includes energy streams, such as hydrocarbon gas and hydrogen gas, and data streams. At step 310, gas is received from sources such as wells 50 (FIG. 2). At step 212, the received gas is increased to a selected transmission pressure at suitable locations 53 (FIG. 2) along the main distribution line 52 (FIG. 2). It should be understood that the energy added to the received gas is used to transport the gas to one or more desired locations. Upstream of such locations, the gas is directed to a pressure letdown station at step 314 where the gas pressure is dropped from the transmission pressure to a distribution pressure suitable for the location that receives the gas. Alternatively or additionally, the gas pressure may be dropped from the transmission pressure to a lower pressure at other locations, such as that described in connection with FIG. 3.

In accordance with the present disclosure, some or all of the reduction in pressure of the gas is used to generate electricity as step 316. It should be noted that this electricity is generated without burning hydrocarbons. Thus, at step 332 carbon credits may be awarded for the generation of this electricity. The generated electricity may be used in at least two ways. At step 322, the electricity may be used to energize data processing equipment, which generates data that may at step 330 transmitted wirelessly or via fiber optic lines to a receiver. At step 324, which may be in addition or alternative to step 322, the electrical energy is used to energize a hydrogen generator. The hydrogen gas may be transmitted at step 328 to a receiver via the pipeline 52 (FIG. 2) and/or a suitable transport vehicle. It should be noted that the hydrogen is generated without burning hydrocarbons. Thus, at step 334 carbon credits may be awarded for the generation of this hydrocarbon gas. At step 327, the generated electricity may be used to energize electrical equipment at or near the letdown station. For example, the generated electricity may be used to energize control equipment, security equipment, computer equipment, servers providing data cache and transmission, lights, etc.

It should be appreciated that the addition of energy at step 312 generates at least two independent product streams and, in this embodiment, three independent product streams, names a data stream 330, a hydrogen stream 328, and a gas stream 326. It should be appreciated that the gas stream 326, which was used to generate electricity has “intrinsic” value, i.e., has value independent of the electricity generation process.

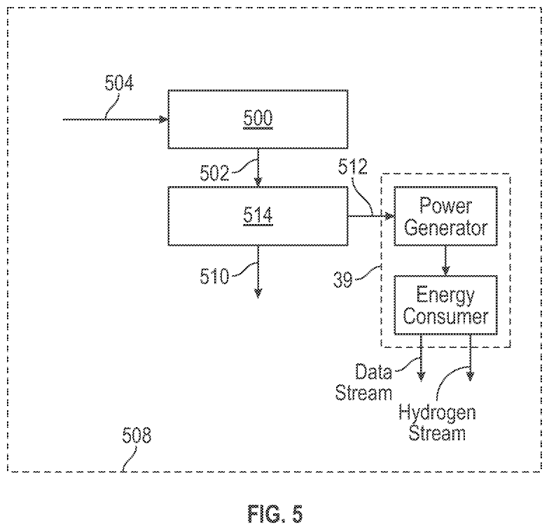

Referring now to FIG. 5, the teachings of the present disclosure may be used in conjunction with a hydrodynamic system 500 that communicates a working liquid 502 using added energy 504 to equipment 514 that that is energized by the working liquid 502 and/or processes the working liquid 502. The hydrodynamic system 500 may be in an off-grid zone 508 that is isolated from an electrical grid. The equipment 514, while processing or using the working liquid 502, generates a main product 510. The equipment 514 also generates an energy byproduct 512, which is used to converted to electricity with a power utilization module 39. The electricity is used by an energy consumer to process data and/or generate hydrogen.

In one non-limiting arrangement, the working liquid may be seawater. Energy is added using pumps that flow the seawater through a reverse osmosis desalination system. The main product is desalinated water. The energy byproduct is a relatively high pressure difference that occurs during desalination. The power generator uses the high differential pressure to generate electricity, which is used by data processors and/or hydrogen generators to generate data streams an/or hydrogen, respectively.

In another non-limiting arrangement, the working liquid may be petroleum. Energy is added using pumps that flow the petroleum to elevated storage tanks. The main product is stored petroleum that has potential energy due to be pumped upwards a specified height. The energy byproduct is a high pressure difference that is present when the petroleum is later released and allowed to flow downwards. The power generator uses the high differential pressure to generate electricity, which is used by data processors an/or hydrogen generators to generate data streams an/or hydrogen, respectively.

Further aspects of the present disclosure include systems for recovering utility from at least one gas under a first pressure in a gas pipeline. Example systems may include a recovery station coupled to the gas pipeline, a digital asset token generation station at the recovery station, and an electrical system. In particular embodiments, the gas comprises natural gas and the recovery station comprises a letdown station.

The recovery station may be configured to pass through at least a portion of the gas at a second pressure lower than the first pressure, and by so doing produce electricity. The recovery station may include an electrical generator, a bypass line in communication with the gas pipeline, and an exit line dispensing gas at the second pressure. An electrical generator may be configured to receive the gas at the first pressure from the bypass line and produce electricity via a difference between the first pressure and the second pressure. For example, the electrical generator may comprise an expansion turbine or reciprocating engine. The electrical system may be configured to provide at least a portion of the electricity from the electrical generator to the digital asset token generation station.

The digital asset token generation station at the recovery station may include at least one processor connected to a network and configured to: i) determine validity of a transaction record received from the network by performing a proof of work operation on the transaction record; and ii) direct storage of digital asset tokens earned from the proof of work operation in memory accessible to the system. The transaction record may be, for example, a blockchain transaction record. The digital asset tokens may be, for example, cryptocurrency. The proof of work operation may include performing a hash operation based on the transaction record.

The recovery station may include at least one sensor configured to measure a parameter value of electricity produced by the electrical generator, and at least one processor configured to estimate a carbon credit based on the parameter value.

The system may optionally include a low temperature mitigation system. Such a system may be configured to contingently provide power from the electrical system power to the low temperature mitigation system. In some implementations, the system may be configured to contingently provide power from the electrical system to the low temperature mitigation system in dependence upon the carbon credit, the price of hydrogen, expected costs or severity of low temperature effects on the system, the pipeline, or other affected infrastructure, and so on. As another example, in the case that the system includes a digital asset token generation station, the system may be configured to estimate a monetary value associated with digital asset production from the digital asset token generation station, and contingently provide power from the electrical system to the low temperature mitigation system in dependence upon the monetary value.

Further aspects of the present disclosure include systems for producing carbon credits from a gas pipeline. The gas pipeline may have at least one gas under a first pressure. Example systems may include a recovery station coupled to the gas pipeline, a hydrogen generation station at the recovery station, an electrical system, and at least one processor configured to estimate a carbon credit based on the parameter value. In particular embodiments, the gas comprises natural gas and the recovery station comprises a letdown station.

The recovery station may be configured to pass through at least a portion of the gas at a second pressure lower than the first pressure, and by so doing produce electricity. The recovery station may include an electrical generator, a bypass line in communication with the gas pipeline, and an exit line dispensing gas at the second pressure. An electrical generator may be configured to receive the gas at the first pressure from the bypass line and produce electricity via a difference between the first pressure and the second pressure. For example, the electrical generator may comprise an expansion turbine or reciprocating engine. The electrical system may be configured to provide at least a portion of the electricity from the electrical generator to the hydrogen generation station.

The hydrogen generation station may include a water source; an electrolysis module configured to convert water from the water source into hydrogen and oxygen by electrolysis; and at least one sensor configured to measure a parameter value of the hydrogen. The system may further include a hydrogen injection system configured to add at least a portion of the hydrogen to the gas from the exit line and/or a hydrogen reservoir coupled to the electrolysis module and configured to store at least a portion of the hydrogen.

The system could optionally also include a digital asset token generation station as described above at the recovery station. The at least one processor may optionally be configured to determine an estimated monetary value of the carbon credit and modify provision of electricity to at least one of the digital asset token generation station and the hydrogen generation station in dependence upon the estimated monetary value of the carbon credit. The at least one processor may optionally be configured to determine an estimated monetary value of the carbon credit and an estimated monetary value of at least one of the portion of electricity provided to the hydrogen generation station and the second portion provided to the digital asset token generation station; and modify provision of electricity to at least one of the digital asset token generation station and the hydrogen generation station in dependence upon the estimated monetary value of the carbon credit and the estimated monetary value of each portion of electricity.

The at least one processor may optionally be configured to determine an estimated monetary value of the portion, an estimated monetary value of the second portion, and an estimated monetary value of the carbon credit and modify provision of electricity to at least one of the digital asset token generation station and the hydrogen generation station in dependence upon the estimated monetary value of the portion, the estimated monetary value of the second portion, and the estimated monetary value of the carbon credit.

The system may optionally include a low temperature mitigation system. Such a system may be configured to contingently provide power from the electrical system power to the low temperature mitigation system. In some implementations, the system may be configured to contingently provide power from the electrical system to the low temperature mitigation system in dependence upon the carbon credit, the price of hydrogen, expected costs or severity of low temperature effects on the system, the pipeline, or other affected infrastructure, and so on. For example, the system may be configured to estimate a monetary value of the hydrogen, and contingently provide power in dependence upon the monetary value. In some possible implementations, the low temperature mitigation system may operate on hydrogen, and the system may be configured to contingently provide hydrogen to the low temperature mitigation system in dependence upon the carbon credit, the price of hydrogen, expected costs or severity of low temperature effects on the system, the pipeline, or other affected infrastructure, and so on. The system may be configured to estimate a monetary value associate with the produced hydrogen, and contingently provide hydrogen to the low temperature mitigation system in dependence upon the monetary value.

The foregoing description is directed to particular embodiments of the present disclosure for the purpose of illustration and explanation. It will be apparent, however, to one skilled in the art that many modifications and changes to the embodiment set forth above are possible without departing from the scope of the disclosure. It is intended that the following claims be interpreted to embrace all such modifications and changes.

What is claimed is:

1. A method of generating and utilizing electrical energy, comprising:
providing at least one pressure increasing node at a first selected location along the pipeline, the at least one pressure increasing node configured to increase a pressure of the gas in the pipeline to at least a predetermined value;
providing at least one self-sustaining node at a second selected location on the pipeline that is downstream of the first selected location, the at least one self-sustaining node including at least one energy extractor and the energy consumer, the at least one energy extractor being configured to generate electricity by converting a differential pressure of a gas in the pipeline to electrical energy;
flowing a gas along a pipeline;
generating the electricity by reducing the pressure of the gas at selected locations along the pipeline using the at least one energy extractor; and
operating an energy consumer using at least a portion of the generated electricity.

2. The method of claim 1, further comprising:
bypassing a pressure reduction valve along the pipeline with the at least one energy extractor, the at least one energy extractor including a turboexpander and a generator; and
generating the electricity using the turboexpander and the generator;

3. The method of claim 1, wherein the gas is a natural gas.

4. The method of claim 1, further comprising:
generating hydrogen using at least a portion of the generated electricity; and
conveying at least a portion of the generated hydrogen using the pipeline.

5. The method of claim 1, further comprising processing data using at least a portion of the generated electricity; and
transmitting at least a portion of the processed data to at least one receiver using at least one of: (i) a wireless transmitter, and (ii) at least one fiber optic cable.

6. The method of claim 5, wherein the data is associated with cryptocurrency.

7. The method of claim 6, wherein the generating electricity step, the processing data step, and the data transmitting step have a substantially net zero carbon emission.

8. The method of claim 1, wherein the energy consumer is one of: (i) processing hardware configured for cryptocurrency mining, (ii) a data center, and (iii) a hydrogen generator.

9. The method of claim 1, further comprising generating the electricity using: (i) a high speed turboexpander impeller connected to a gear reduction unit, (ii) a positive displacement rotary unit that expands the gas through a screw type expander, (iii) a reciprocating piston type expander, and (iv) a high speed turboexpander impeller connected directly to a shaft of an electrical generating device.

10. The method of claim 1, wherein none of the generated electricity is transmitted to a utility power grid.

11. A system for nodal electrical energy generation and consumption for a natural gas pipeline, comprising:
(a) at least one pressure increasing node at a first selected location along the pipeline, the node configured to increase a pressure of the gas in the pipeline to at least a predetermined value; and
(b) at least one self-sustaining node at a second selected location on the pipeline that is downstream of the first selected location, the at least one-self sustaining node including at least one energy extractor and at least one energy consumer, the at least one energy extractor being configured to convert a differential pressure of a gas in the pipeline to electrical energy.

12. The system of claim 11, wherein the at least one energy consumer is one of: (i) processing hardware configured for cryptocurrency mining, (ii) a data center, and (iii) a hydrogen generator.

13. The system of claim 11, wherein the at least one energy extractor is one of: (i) a high speed turboexpander impeller connected to a gear reduction unit, (ii) a positive displacement rotary unit that expands the gas through a screw type expander, (iii) a reciprocating piston type expander, and (iv) a high speed turboexpander impeller connected directly to a shaft of an electrical generating device.
